(19) United States
(12) Patent Application Publication
(10) Pub. No.: US 2007/0275173 A1
(43) Pub. Date: Nov. 29, 2007

(54) Foamed polymeric lining for earthen pits and methods for installing the same

(76) Inventor: Phillip L. Lawson, Midland, TX (US)

Correspondence Address: CLEMENTS WALKER, 1901 ROXBOROUGH ROAD, SUITE 300, CHARLOTTE, NC, 28211, US

(21) Appl. No.: 11/655,480

(22) Filed: Jan. 19, 2007

Related U.S. Application Data
(60) Provisional application No. 60/787,940, filed on Apr. 3, 2006.

(51) Int. Cl. B05D 3/00

(52) U.S. Cl. 427/386; 106/285; 106/287.25; 405/129.45; 427/385.5; 428/68

(57) ABSTRACT

A method and liner for a reserve earthen pit for use in onshore drilling operations has a foamed polymeric composition. At least one layer of the continuous foamed polymeric composition is applied to the interior surface of the reserve earthen pit, preferably after the native soil has been compacted, thereby forming a sealed liner barrier between the native soil and the interior of the pit. The composition is resistant degradation from the drilling muds that are stored within the pit. UV protectants may also be added to the pit liner composition.

### CROSS-REFERENCE TO RELATED APPLICATION

This application claims the benefit under 35 U.S.C. §120 of U.S. Provisional Application No. 60/787,940 filed on Apr. 3, 2006.

### BACKGROUND OF THE INVENTION

1. Field of the Invention

The invention relates to continuous polymeric liners for use in coating earthen pits, such as reserve pits, used in onshore drilling operations. Specifically, the current invention is related to foamed polymeric pit liners, and a method of applying foam polymer to an excavated pit, preferably without using fluorinated hydrocarbons. More specifically, a continuous closed-cell urethane foamed polymeric composition is sprayed onto the surfaces of the excavated pit and cured to create a polymeric lining impermeable to brine, petrochemicals, and other waste commonly contained in the reserve pits of onshore drilling operations.

2. Description of Related Art

In onshore natural gas and oil drilling operations, drilling mud is used to remove cuttings produced by the bit at the bottom of the hole and to carry them to the surface. Drilling mud is circulated down through the drill pipe, drill collars, and bit where it encounters the cuttings. Cuttings are then carried in the mud back to the surface by means of the well bore and the conductor pipe. A shale shaker separates the cuttings from the mud. The mud is then directed into a mud tank or reserve pit for recirculation through the drilling apparatus and the bore hole.

In the past, drilling mud referred to a mud containing bentonite clay, water, and caustic soda. Barite was optionally added to obtain a desired density. Lignite or lignosulfonate could also have been included. However, modern drilling does not necessarily recognize conventional muds. Indeed, conventional betonite muds are scarcely used today.

Polymer muds, special drill-in fluid, and synthetic muds are more common in modern drilling operations. Modern drilling muds are therefore broadly defined as any of a number of liquid fluids and mixtures of fluids and solids (as solid suspensions, mixtures and emulsions of liquids, gases and solids) used in operations to drill boreholes into the earth. Modern drilling muds generally can be aqueous based, hydrocarbon based, polymeric based, or combinations thereof. Of these, polymeric muds are currently preferred. Modern drilling muds can also contain calcium and/or sodium hydroxides, resulting in a very alkaline solution. Surfactants, brine, salts, and other additives may also be present.

Reserve pits are generally used for storage or disposal of water, drilling mud, and cuttings during drilling operations. Pits are typically excavated to a depth of between 10 and 15 feet below the surrounding ground covering about an acre on average and provide adequate storage for the drilling muds. Thus pits may be larger or smaller depending on the estimated depth of the well itself. Especially where the natural soil has a large clay component, the soil walls of the pit are compacted to prevent seepage of the mud into the environment.

Brine, salts, alkaline ions, surfactants, petroleum materials, and other materials contained within the drilling mud can seep through the pit walls and contaminate ground water and the surrounding soil. When pits containing moderate or high levels of hydrocarbons, chloride ions and other additives are anticipated, the reserve pits can be provided with an impermeable barrier to prevent soil and ground water contamination. Barriers have typically included polymeric/synthetic sheet liners or compacted bentonite or clay.

Natural bentonite or clay must be sufficiently compacted to create an impermeable barrier. A small area of the pit that is not sufficiently compressed can compromise the integrity of the entire pit, leading to large amounts of escaped contaminants from the drilling mud. Furthermore, any contaminated bentonite or clay must be removed from the drilling site once operations have concluded.

Polymeric sheet liners applied over an excavated reserve pit are subject to abrasions and punctures from the subadjacent soil, from sharp rock edges, for example. This leads to leaks that must be repaired. Likewise, if seams between adjacent rolls of polymeric material are not sufficiently sealed, leaks can occur. Leaks in the reserve pit can cause significant drilling operation down time while the leak is isolated and repaired.

U.S. Statutory Invention Registration No. H573 to Deely, published Feb. 7, 1989, discloses a method for sealing the bottom of a pit to minimize leakage. A sealing material, preferably an admixed soil liner in combination with bentonite clay or a bentonite/polymer (e.g., polyurethane-polymer) mixure, is mixed with native soil, in a mixing tank. A pump and hose is then connected to the fluid mixing tank, and a layer of the sealing material is dispensed from the fluid mixing tank through the pump and hose and onto the bottom and sides of the pit, e.g., a disposal pit. The dispensed layer of sealing material coats the bottom and sides of the pit, forming a barrier therein. Waste material is removed from the pit after use of the pit is concluded. Optionally, a second batch of sealing material can then be pumped from the mixing tank, dispensing a layer of the sealing material on top of the waste material remaining in the pit, effectively containing the waste material between the two layers of sealing material.

U.S. Pat. No. 4,125,983 issued to Jarrell, dated Nov. 21, 1978, discloses a unitary liner for an earthen pit. The liner is fabricated in situ from a multiplicity of flexible fiberglass panels bonded together to form a unitized membrane that is impervious to brine, crude and drilling mud. The fiberglass panels are prefabricated and rolled into cylinders for delivery to the pit site where field fabrication of the membrane is completed by overlapping edges of the panels to one another, and subsequently bonding the panels together with fiberglass cloth and polyester resin, to form a seam. The fiberglass panels are made up of a plurality of sheets of paper and fiberglass cloth bonded together by fiberglass resin.

U.S. Pat. No. 4,344,722 issued to Blais, dated Aug. 17, 1982, discloses a system and method for waterproofing a desired substrate with a chemical-resistant product. A length of thin flexible moisture-permeable synthetic sheet material having desired characteristics is placed in contact with the substrate. A layer of montmorillonite clay is then applied on top of the synthetic sheet. A final fabric layer is then applied atop the layer of clay.

U.S. Pat. No. 5,185,383 issued to Regenauer discloses sprayable urethane closed-cell foams. This patent is hereby incorporated by reference as it discloses a foam that has good density and compression strength, and is suitable for the present invention.

Thus, it is an object of the invention to provide an improved reserve pit liner that overcomes these and other problems in the prior art.

### SUMMARY OF THE INVENTION

To achieve the foregoing and other objects, and in accordance with the purposes of the invention as embodied and broadly described herein, the present invention provides various embodiments of a foamed polymeric liner used in the construction of earthen pits.

The invention relates to continuous polymeric liners for use in coating earthen pits such as reserve pits used in onshore drilling operations for oil or natural gas wells. The pits will contain drilling mud or drilling workover fluids. These muds or fluids are usually aqueous based. Specifically, the invention relates to closed cell foamed polymeric pit liners, and methods of applying the foam coating to an excavated pit.

Briefly, the present invention excavates a hole in the ground or mounds earth up from the earth's surface thereby forming a reserve earthen pit. A foamed polymer composition is then blown onto the fluid holding surfaces (the sides, walls and bottom) of the pit and allowed to cure thereby forming closed cell foam. Various additives, including UV stabilizers, antioxidants, cellular stabilizers, etc., can be added to the composition depending on the desired properties of the resulting foam.

In the broadest sense, the present invention comprises a reserve pit liner for use in holding drilling fluids, comprising: an earthen pit, and a continuous foamed polymeric composition having a thickness of at least 1.5 inch applied to the surface of the said earthen pit, said polymeric composition being resistant to chemical degradation from constant contact with drilling mud.

In the broadest sense, the present invention also comprises a method of installing a continuous polymeric pit liner into an earthen pit, said method comprising: providing an earthen pit, providing a polymeric composition; incorporating a foaming agent into said polymeric composition; coating said composition onto the surface of said earthen pit; allowing the composition to foam, and allowing said foam coating to cure, thereby forming a closed cell foam.

The various features of novelty that characterize the invention are pointed out with particularity in the claims thus forming a part of the disclosure. For a better understanding of the invention, its operating advantages, and specific objects attained by its use, reference should be made to the descriptive matter in which there are illustrated and described preferred embodiments of the invention. It should be recognized by those skilled in the art that the specific embodiments disclosed herein may be readily modified for carrying out the same or similar purposes as that of the present invention. Such equivalent constructions should not be deemed to depart from the spirit and scope of the present invention as set forth in the appended claims.

### DETAILED DESCRIPTION OF THE INVENTION

The method of the present invention needs an earthen pit. This pit can be dug or earth can be mounted up on the earth's surface to create a pit, or a combination of both. The pit size may be about 150 feet by 150 feet or smaller, or as large as an acre or larger. They may be shallow such that they hold 200 barrels of fluid or deep and large such that they hold 15,000 barrels. The strength and thickness of the foam polymeric liner therefore varies greatly as a result.

Polymeric material useful in the current invention can be supplied from flake, chip, or other material.

Typical polymers capable of being foamed include polyurethanes, cellulose acetates, phenolics, polystyrenes, urea formaldehydes, styrene acrylonitriles, silicones, polyvinyl chloride, polyethylenes, and epoxies, or copolymers or mixtures of these. Polyurethanes are preferred. While the embodiment described here is directed to polyurethane, the other polymers are suitable.

The first embodiment of the invention for making polyurethane foam is a hydroxyl group containing component to use in a system for creating polyurethane foam without the use of fluorinated hydrocarbons comprising, a component A and a component B in a 1:1 volume ratio, and as component A, an organic polyisocyanate materials in the formula R(NCO).sub.n, where R represents polyfunctional, optionally, urethane, biuret, carbodiimide, and isocyanurate group-containing aliphatic, cycloaliphatic, araliphatic, or preferably aromatic radicals or mixed radicals of the type. n is a whole number whose value is equal to the valence of R and is at least 2, for example from 2 to 6, and preferably from 2 to 3. Typical examples for making polyurethane include aliphatic di-isocyanates such as ethylene di-isocyanate, 1,2-propylene di-isocyanate, 1,4-butylene di-isocyanate, 2,2,4-trimethylhexamethylene-1,6-di-isocyanate, 2-ethylbutylene 1,4-di-isocyanate, and preferably 1,6-hexamethylene di-isocyanate cycloaliphatic di-isocyanates such as 1,2-cyclohexane di-isocyanate, 1,4-cyclohexane di-isocyanate, 1-methylcyclohexane 2,4-di-isocyanate and 2,6-di-isocyanate as well as corresponding isomer mixtures, 4,4′-, 2,4′-, and 2,2′-dicyclohexylmethane di-isocyanate as well as corresponding isomer mixtures, and preferably 3-isocyanatomethyl 3,5,5-trimethylcyclohexylisocyanate, and polyisocyanate such as polycyclohexylpolymethylene polyisocyanates having from 2 to 6, preferably 3, cyclohexylene radicals in the molecule, and preferably aromatic polyisocyanates such as meta- or para-phenylene di-isocyanates, biphenyl di-isocyanate, 2,4- and 2,6-toluene di-isocyanate and corresponding isomer mixtures, 4,4′-, 2,4′-, and 2,2′-diphenylmethane di-isocyanate and corresponding isomer mixtures, mixtures of 4,4′-, 2,4′-, and 2,2′-diphenylmethane di-isocyanates and polyphenyl polymethylene polyisocyanates (polymeric MDI) and mixtures of polymeric MDI and toluene di-isocyanates.

As component B, the system includes the hydroxyl group containing component which consists essentially of a mixture of at lest one member of the group of factors (i) and (ii). Factor (i) consists essentially of a condensation product of an aliphatic triol, propanol or ethanol. The aliphatic chain length is suitably from 3 to 20 carbon atoms prior to condensation, preferably from 3 to 12 carbon atoms. The condensation product, having an hydroxyl number of about 50 to 650 has molecular weight of from about 250 to about 1600.

These condensation products are produced by conventional methods which are well known in the art.

These ethoxylated or propoxylated triols reduce the viscosity of the B component and enhance the curing of the foam material.

Factor (ii) consists essentially of a condensation product of a hexose with propanediol or propanetriol. Suitable hexoses include linear or cycloaliphatic hexoses which may be either industrially produced or naturally derived. Suitable propanediols include 1,1-propanediol, 1,2-propanediol, and 1,3-propanediol. Suitable propane triols include 1,1,1-propane triol, 1,1,2-propane triol, 1,1,3-propane triol, as well as all other propane triol permutations. These propanediols and propanetriols are made by conventional methods. The condensation of the propanediols or triols with hexose is performed by conventional reactions well known in the art. Other components suitable for use in the present invention are also disclosed in U.S. Pat. No. 5,185,383 to Regenauer.

The polymeric material can be foamed by mechanical, physical, or chemical foaming agents, so long as the desired physical characteristics of the foam are maintained such that the green foam does not collapse. Typically the polymeric composition is liquefied, by heating, for example, and foaming agent is then introduced to the composition, typically in a 1:1 volume ratio. In a chemical foaming process, an expanded gas is generated in situ within the polymer composition. The gas can be produced as a part of a chain extending or cross-linking reaction, or brought about by the addition of a foam-forming additive, such as sodium bicarbonate or metallic powders. Physical foaming agents are compounds that undergo a physical state change during processing.

Typical physical foaming agents, or blowing agents, can be used to generate the foamed composition. These agents undergo a state change. Depending on the specific polymer composition employed, useful blowing agents include, but are not limited to carbon dioxide; aliphatic hydrocarbons, such as pentane, neopentane, hexane, isohexane, heptane, isoheptane, benzene, and toluene; aliphatic halogenated hydrocarbons, such as methylene chloride, trichloroethylene, and dichloroethane; and aliphatic fluorocarbons, such as dichlorotetraflouroethane, trichloroflouromethane, and trichloroflouroethane, as well as derivatives and combinations thereof.

Also contemplated are chemical foaming agents that generate a gas in situ, usually formed as a by-product of a chain-extension or cross-linking reaction. These are typically organic or inorganic materials that decompose under the influence of heat, having at least one gaseous product. These compounds can include azo-compounds, such as azobisformaldehyde, azobisisobutyronitrile, and diazoaminobenzene; n-nitroso-compounds, such as N,N′-dimethyl-N,N′-dinitrosoterephthalamide, and N,N′-dinitrosopentamethylenetetramine; and sulfonyl hydrazides, such as benzenesulfonyl-hydrazide, toluene-(4)-sulfonyl hydrazide, and benzene-1,3-disulfonyl hydrazide. Other compounds include hydroxyl groups and these foaming compounds are preferably not fluorinated hydrocarbons. The foaming compounds in U.S. Pat. No. 5,185,383 are typical in the industry and suitable for the present invention. The continuous polymeric foams formed in accordance with the present invention may be rigid, semi-rigid, or flexible, depending on the foam characteristics, method of preparing, method of applying, optional ingredients, temperature and pressure, etc. as is known to those skilled in the art.

Various on site mixers, agitators, percolators, and other mechanical devices can also be used to introduce gas to the molten polymer composition, thereby foaming the composition.

Various curing agents can also be added to the polymeric composition to help retain the cellular structure of the foamed polymer during curing. Other additives can include fire retardants, dyes, colorants, nucleating agents, and hydrolysis inhibitors.

The foamed composition may optionally contain heat, ultraviolet, or oxidation stabilizers. These additive stabilizers retard or eliminate the degradation reactions that can cause discoloration, embrittlement, and the loss of other physical properties of the foamed composition. Ultraviolet attack on the foam will be essentially limited to areas that are above the mud level in the pit.

Ultraviolet stabilizers are materials that preferentially absorb large amounts of ultraviolet energy and are able to reemit it at nondestructive wavelengths. Such absorbers can include benzophenones, such as 2,4-dihydroxy-benzophenone, 2,2-dihydroxy-4,4′-dimethoxy-benzophenone, 2,2′-4,4′-tetrahydroxy-benzophenone, 2-hydroxy-4-alcoxybenzophenone, 2-hydroxy-4-methoxy-benzophenone, 2,2′-dihydroxy-4-methoxy-benzophenone, 2-hydroxy-4-n-octoxy-benzophenone, 2-hydroxy-4-methoxy-2′-carboxybenzophenone, 2-hydroxy-4-methoxy-5-sulfo-benzophenone trihydrate, and 4-dodecyloxy-2-hydroxy-benzophenone; benzotriazoles, such as 2(2′ hydroxyl-5-methylphenyl)benzotriazole, substituted 2,2′-hydroxy-phenyl benzotriazone, and substituted 2,2′-hydroxy-phenyl benzotriazole; salicylates, such as p-octophenyl salicylate; substituted acrylonitriles, such as 2-ethyl-hexyl-2-cyano-3,3-diphenyl acrylate, and ethyl-2-cyano-3,3-diphenyl acrylate; nickel organic complexes, such as nickel bisoctyl phenyl sulfide; and monobenzoates, such as resorcinol monobenzoate.

Heat stabilizers and antioxidants include epoxy compounds, such as glycidyl ethers and esters, epoxidized esters of aliphatic acids, and alicyclic epoxy esters of aliphatic and aromatic acids and alcohols; nitrogen containing organic compounds, such as amines, amides, of orphaning and inorganic acids, and heterocyclic compounds; phosphites, including alkyl-, aryl-, alkyl-aryl-, and alkylated aryl phosphites; and metallic salts (such as barium, cadmium, zinc, lead, calcium, strontium, sodium, and potassium) of inorganic acids, organic acids, and phenols. Carbon black and titanium dioxides are also effective.

The foam material is a crosslinked polymer that is generally insoluble and nontoxic. It must be resistant to alkaline aqueous solutions of both calcium hydroxide and/or sodium hydroxide contained in the drilling muds. High concentrations of salt or brine—concentrations of 10 lb./gallon brine are not uncommon. The foam is also exposed to incidental contact with crude oil, although not in large amounts. Furthermore, the foam should be resistant to etching and abrasion from the surrounding soil.

When applied, the continuous foamed composition must be able to fill substrate irregularities and level the surface, and withstand the pressures exerted by the contained drilling mud. If the foam were to collapse under the weight of the contained mud, cracks and abrasion leaks in the pit liner are more likely. During installation of the foam, and in repair thereof, an operator must walk atop the foam to the distressed areas of the foamed pit liner. Therefore, the foamed composition for a 10 foot deep earthen pit should have adequate compressive strength to support a person walking atop the foam. The foam for a 10 foot deep earthen pit has a minimum thickness of about 1 inch, preferably about 1.5 inch, and more preferably between 2 and 3 inches, and greater than about 5 inches is economically wasteful.—providing no additional benefit. If the earthen pit is more shallow, the thickness of the liner can be reduced. For example, if there is already a shallow depression in the ground that would be adequate as an earthen pit, then the foam may be only a ½ inch thick. What is desirable is that the liner is continuous and has a thickness to handle the load placed upon it. To aid in the liner being continuous, it is preferable to compact the soil to some extent, depending on the depth of the water head. Loose soil will only stress the foam liner unnecessarily.

While a compressive strength of only 10 pounds per square inch is sufficient to maintain the cellular integrity of the foam from compression by a 10 ft. water head of drilling mud, a compressive strength of about 20 pounds per square inch is preferable to ensure foam integrity under conditions where an operator is walking the foamed liner. Additionally, it is preferred that the foam should have a density of greater than about 1.5 lb./ft.³, preferably about 3 lb./ft.³. A density greater than 5 lb./ft.³ is not economically feasible, in that application of the foamed polymeric composition requires special equipment to mix, foam and apply. Foams within this density range have the above characteristics for a 10 foot water head. For shallower water heads, the density can be reduced. It is only necessary that the foam be able to support the load placed upon it.

It is preferred that the foam be applied to the pit as two separate continuous layers. By curing one continuous layer, and then applying an additional continuous layer atop the first, the risk that foam defects leading to leakage is lessened. Further, the foam can be applied to greater thicknesses by using a two-layer system. Single layer systems risk the weight of the uncured foam collapsing the regions of the pit liner directly adjacent the surrounding soil, increasing the chances for a fault in the pit liner. The two layers can be of similar or different compositions. Because only the top layer will be exposed to the mud, it may be of benefit to include additives in the top layer that are not included in the lower layer. These additives are described above.

The foam should be applied at temperatures above the dew point to prevent excess moisture from entering the sprayed on polymeric composition. For example temperatures below freezing do not impede spraying the foam if the dew point is not reached. When the composition is applied, it will typically foam to useable levels within a few minutes. A curing time of 24 hours is generally used, although shorter or longer cure times may be necessary depending on the composition of the polymeric composition and the ambient conditions of the soil and atmosphere, as well as the amount of any catalyst. These matters are well known to those skilled in the art. Coatings that are applied atop the polymeric liner will also vary in cure times, with polyurea coatings typically curing within a few hours and acrylic coatings curing over several days.

Foam pit liners of the present invention typically last 30 to 45 days, but can be employed for as little as about 5 days and for as long as about 1 year. U.V. attack will essentially be that portion above the fluid level that is exposed to the sunlight. Foams are subject to U.V. attack, but this is a problem if the foam liner is in place more than about 2 months. Accordingly there is not a need for U.V. stabilizers, or only a little need, at best. The foam liner may be buried in place, but digging them up, cutting them up, and disposing of them is also possible. If the foam pit liner is layered, only the top layer need contain the U.V. stabilizer. Any conventionally known U.V. stabilizer compatible with the foam as well as the fluid is suitable. Optionally, a small amount of pigment such as carbon black or TiO₂ (0.5 to 2 wt. %, based on the weight of the foam) is sufficient to substantially improve the foams resistance to U.V. attack and this may be used in addition to or instead of U.V. stabilizer. Covering the foam with a U.V. protective coating is also an option to reduce or eliminate any U.V. attack by the sun's light. Coatings may include polyurea, polyurethane-co-urea, acrylics, ethylene-propylene rubber, epoxies, or asphalt are also helpful, and these coating may or may not contain pigments.

### EXAMPLE 1

A foam made in accordance with the present invention is described in Table I. The foam is made in accordance with Example II of U.S. Pat. No. 5,185,383.

TABLE I

| Ingredient | % by weight |
|---|---|
| Component A | |
| diphenylmethane di-isocyanate (2.2–2.4) | 125.0% |
| Component B | |
| oxypropylated and ethylated glycerol | 30.0–11.8% |
| aliphatic amino polyol | 24.0–40% |
| propoxylated sucrose/propoxylated glycerol | 12.5–12.5% |
| polyalkylene oxide polyol | 15.0–15.0% |
| tri(1-chloromethyl and tri(2-chloro-iso-propyl)) | 15.0–15.0% |
| H₂O | 4.0–1.2% |
| Polysiloxane | 1.0–1.0% |
| triamine/diethylene amine | 1.0–1.0% |
| Pentamethyl diethylene triamine | 0.5–0.5% |
| Tris(3-dimethylamine) propylamine | 2.0–2.0 |

The mixing components A to B in the novel foam is 100 parts of component A to 100 parts of component B, or 1:1 by volume. The density of the resultant foam is 1.5-3.0 pcf.

### EXAMPLE 2

A foam composition was prepared according to U.S. Pat. No. 5,185,383 and was sprayed on several small earthen pits to produce a closed-cell 3 pound per cubic foot foam. The foam liner was produced by applying several layers—spray, dry and cure, spray again. Water was placed in the lined earthen pit and several weeks later it was still being retained. Moreover, before the water was placed in the earthen pits, the inventor walked on top of one of the foam liners with no apparent effect.

From the foregoing, it is readily apparent that I have invented an improved polymeric liner and method for the application thereof for use in reserve pit during drilling processes. A foamed polymeric composition is sprayed onto the surfaces of the excavated pit to create a polymeric lining impermeable to brine, petrochemicals, and other waste commonly contained in the reserve pits of onshore drilling operations.

During operation of the pit, the foamed polymeric composition provides an impermeable barrier to brine, petrochemicals, and other waste commonly contained in the reserve pits of onshore drilling operations.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

I claim:

1. A reserve pit liner for use in drilling, comprising.: an earthen pit,
a continuous foamed polymeric composition applied to the surface of the said earthen pit,
said polymeric composition being resistant to chemical degradation from constant contact with drilling mud.

2. The pit liner of claim 1, wherein said foamed polymeric composition is selected from the group consisting of polyurethanes, cellulose acetates, phenolics, polystyrenes, urea formaldehydes, styrene acrylonitriles, silicones, polyvinyl chloride, polyethylenes, epoxies, and combinations thereof.

3. The pit liner of claim 1, wherein said polymeric composition further comprises:
at least one physical or chemical foaming agent.

4. The pit liner of claim 3, wherein said physical foaming agent is selected from the group consisting of carbon dioxide, aliphatic hydrocarbons, aliphatic halogenated hydrocarbons, aliphatic fluorocarbons, and combinations thereof.

5. The pit liner of claim 3, wherein said chemical foaming agent is selected from the group consisting of azo-compounds, n-nitroso-compounds, and sulfonyl hydrazides.

6. The pit liner of claim 1, wherein said polymeric composition further comprises at least one ultraviolet stabilizer.

7. The pit liner of claim 6, wherein said ultraviolet stabilizers are selected from the group consisting of benzophenones, benzotriazoles, salicylates, substituted acrylonitriles, nickel organic complexes, monobenzoates, and combinations thereof.

8. The pit liner of claim 1, wherein said polymeric composition comprises at least one heat stabilizer.

9. The pit liner of claim 8, wherein said heat stabilizer is selected from the group consisting of epoxy compounds, nitrogen containing organic compounds, phosphites, metallic salts of inorganic acids, metallic salts of organic acids, metallic salts of phenols, carbon black, metallic oxides, and combination thereof.

10. The pit liner of claim 1 further comprising protectant topcoats applied atop the polymeric composition.

11. The pit liner of claim 10, wherein said protectant topcoat is selected from the group consisting of polyurea, polyurethane-co-urea, acrylics, polyethylene, polypropylene, epoxies, asphalt, or combinations thereof.

12. The pit liner of claim 1, said pit liner having a density of between about 1.5 lbs per cubic foot and about 5 lbs per cubic foot.

13. The pit liner of claim 1, wherein said pit liner has a compressive strength of at least 10 lbs per square inch.

14. A method of installing a polymeric pit liner into an earthen pit, said method comprising:
providing an earthen pit,
providing a polymeric composition;
incorporating a foaming agent into said polymeric composition;
coating said composition onto the surface of said earthen pit;
allowing the composition to foam, and
allowing said coating to cure.

15. The method of claim 14, wherein said polymeric composition comprises at least one of polyurethanes, cellulose acetates, phenolics, polystyrenes, urea formaldehydes, styrene acrylonitriles, silicones, polyvinyl chloride, polyethylenes, epoxies, and combinations thereof.

16. The method of claim 14, wherein said polymeric composition further comprises at least one ultraviolet stabilizer.

17. The method of claim 16, wherein said ultraviolet stabilizers are selected from the group consisting of benzophenones, benzotriazoles, salicylates, substituted acrylonitriles, nickel organic complexes, monobenzoates, and combinations thereof.

18. The method of claim 14, wherein said polymeric composition comprises at least one heat stabilizer.

19. The method of claim 18, wherein said heat stabilizer is selected from the group consisting of epoxy compounds, nitrogen containing organic compounds, phosphites, metallic salts of inorganic acids, metallic salts of organic acids, metallic salts of phenols, carbon black, metallic oxides, and combinations thereof.

20. The method of claim 14, wherein foaming said polymeric composition comprises adding at least one chemical foaming agent or physical foaming agent.

21. The method of claim 20, wherein said physical foaming agent is selected from the group consisting of carbon dioxide, aliphatic hydrocarbons, aliphatic halogenated hydrocarbons, aliphatic fluorocarbons, and combinations thereof.

22. The method of claim 20, wherein said chemical foaming agent is selected from the group consisting of azo-compounds, n-nitroso-compounds, and sulfonyl hydrazides.

23. The method of claim 14, wherein the step of applying said composition to said pit comprises applying said composition to form a foam of at least inch in depth.

24. The method of claim 23, wherein said composition is applied to a depth of between about 2 and about 3 inches.

25. The method of claim 14, wherein said composition has a post curing density of between about 1.5 lbs per cubic foot and about 5 lbs per cubic foot.

26. The method of claim 14, further comprising protectant topcoats applied atop the polymeric composition.

27. The method of claim 26, wherein said protectant topcoat is selected from the group consisting of polyurea, polyurethane-co-urea, acrylics, polyethylene, polypropylene, epoxies, asphalt, or combinations thereof.

28. The method of claim 14, wherein said cured composition has a compressive strength of at least 10 lbs per square inch.

29. The method of claim 14, further comprising applying a second layer of said composition atop said first layer, after said first layer has been allowed to cure.

30. The method of claim 14, wherein said step of incorporating a foaming agent into said polymeric composition forms a sprayable two component system for creating polyurethane foam without the use of fluorinated hydrocarbons consisting essentially of a mixture of at least one member selected from the group consisting of factors (i) and (ii),
i) a condensation product of an aliphatic triol with propanol or ethanol,
ii) a condensation product of a hexose with propane diol or propane triol, and
iii) a polyol selected from the group consisting of an aliphatic aminopolyol, aliphatic polyester polyols and aliphatic polyether polyols,
iv) an aromatic aminopolyol,
v) a polyurethane rapid initiator,
vi) a surfactant,
vii) a catalyst for the hydroxyl/di-isocyanate polymerization reaction, and
viii) water.
